(19) United States
(12) Patent Application Publication
(10) Pub. No.: US 2024/0071202 A1
(43) Pub. Date: Feb. 29, 2024

(54) AGRICULTURAL ALARM SYSTEM WITH GEOFENCE FEATURES

(71) Applicant: BARNTOOLS, LLC, West Des Moines, IA (US)

(72) Inventor: Michael Hansen, Urbandale, IA (US)

(21) Appl. No.: 18/502,522

(22) Filed: Nov. 6, 2023

Related U.S. Application Data
(63) Continuation of application No. PCT/US22/27633, filed on May 4, 2022.
(60) Provisional application No. 63/201,549, filed on May 4, 2021.

(51) Int. Cl. G08B 21/18; G08B 25/00; G08B 27/00; H04W 4/021; H04W 4/14

(52) U.S. Cl. CPC G08B 21/182; G08B 25/009; G08B 27/006; H04W 4/021; H04W 4/14

(57) ABSTRACT

An agricultural alarm system is for use in association with an agricultural production facility. The agricultural alarm system has a geofence outlining a boundary of an agricultural production facility. At least one sensor located within the geofence boundary senses whether a physical property is within a desired range. The geofence is adapted to sense whether a user device is located inside the geofence boundary. At least one computing device is adapted to receive signals from the at least one sensor indicating an alarm condition when the physical property is outside the desired range. The computing device is adapted to cause alarm notifications to be sent to a first group of user devices when the alarm condition exists. The members of the first group are determined based on their presence within the geofence boundary.

### CROSS-REFERENCED TO RELATED APPLICATIONS

This application claims the benefit of PCT Application No. PCT/US2022/027633, filed May 4, 2022, which claims the benefit of U.S. Provisional Patent Application No. 63/201,549, filed May 4, 2021, which is incorporated by reference herein in its entirety.

### FIELD OF THE INVENTION

The present invention relates generally to systems for monitoring the status of an agricultural facility and providing an alarm when a triggering event occurs.

### BACKGROUND OF THE INVENTION

Agricultural production facilities, such as pig barns, chicken houses, green houses, and the like are often monitored to be sure that physical parameters are within desired ranges. These parameters may include temperature, humidity, carbon dioxide levels, water levels, water meter readings, lack of electrical power or tripped breakers, open or closed doors, and the like. When and if one of the parameters is out of the desired range an alarm or other notification may be triggered so that the condition can be investigated and hopefully resolved.

However, current alarm systems suffer from disadvantages. For example, when an alarm is triggered several people may respond to the same alarm causing redundant use of resources. Worse, the recipients of the alarm may believe that another recipient will respond to the alarm, resulting in delayed or even no investigation of the triggering event. This problem is most acute at times when there are no or few people at that facility. Some present alarm systems attempt to solve this problem by providing an acknowledgment system whereby one or more of the alarm recipients can send a notice that they are responding to the alarm condition. However, even these systems that include an acknowledgement feature are inefficient because they send the alarm to people that are away from the site even when there are already people on site who can handle the condition. Furthermore, there is no notice that a responder has actually arrived at the site to investigate the triggering condition.

### SUMMARY OF THE INVENTION

Therefore, it is a principal object, feature, and/or advantage of the disclosed features to overcome the deficiencies in the art.

It is another object, feature, or advantage of the disclosed features to provide an agricultural alarm system that utilizes geofence features to sense the presence of users at an agricultural site in order to determine whom to send alarm notifications, and to inform other users that an acknowledger of the alarm is or has arrived at the site. According to one feature a user's presence at the site is used to dynamically adjust how alerts of alarm conditions are delivered. For example, if a user is registered as being within the geofence, they would be notified first. If a user is registered as being within the geofence, other users would be notified that a user is already on site. If a user is registered as being on site, other users may not be notified for a time period to give the on-site user time to respond first. If no users are initially on site, other users can be notified with a user does arrive on site.

According to one embodiment, the invention relates to an agricultural alarm system that includes a geofence outlining the boundary of an agricultural production facility, at least one sensor located within the geofence boundary for sensing whether a physical property is within a desired range; a plurality of user devices, each user device being associated with a corresponding user; the geofence being adapted to sense whether a user device is located inside the boundary; a central computing device including a nontransitory computer readable media adapted to receive signals from the at least one sensor indicating an alarm condition when the physical property is outside the desired range; the computer readable media sending alarm notifications to a first group of user devices, wherein members of the first group are determined based on their presence within the geofence boundary. The computer readable media may be adapted to send notifications to a second group of user devices

### BRIEF DESCRIPTION OF THE DRAWINGS

The drawings are presented as examples only and may not be to scale unless otherwise indicated.

FIG. 1 is a schematic of an agricultural alarm system that includes a geofence outlining the boundary of an agricultural production facility according to one embodiment of the present invention.

FIG. 2A is a graphic illustration of example Case 1, wherein a sensed parameter is initially within a normal range, then exceeds the normal range into a warning range, and then returns to the normal range.

FIG. 2B is a flowchart of Case 1.

FIG. 2C shows a tile grid with four tiles representing four sensors, and a detail screen on a user device relating to a front vent temperature sensor during a warning event.

FIG. 3A is a graphic illustration of example Case 2, wherein a sensed parameter is initially within a normal range, then exceeds the normal range into a warning range, then exceeds the warning range into an emergency range, and then returns to the normal range.

FIG. 3B is a flowchart of Case 2.

FIG. 3C is a portion of the flowchart of FIG. 3B.

FIG. 3D is a portion of the flowchart of FIG. 3B.

FIG. 3E is a portion of the flowchart of FIG. 3B.

FIG. 3F is a portion of the flowchart of FIG. 3B.

FIG. 4A is a graphic illustration of example Case 3, wherein a sensed parameter is initially within a normal range, then exceeds the normal range into a warning range, then exceeds the warning range into an emergency range, remains in the emergency range even after being acknowledged, and then returns to the normal range.

FIG. 4B is a flow chart of example Case 3, during the period when the sensor remains in the emergency range after being acknowledged.

FIG. 5 is a schematic of an alarm system that includes a feature for providing access to vendors including access to a feed bin with a lid that automatically opens to permit the vendor to dispense feed into the bin without exiting the vendor's truck.

FIG. 6 shows a gateway that may be used in implementing certain embodiments of the present invention.

FIG. 7 shows a water meter that may be used in implementing certain embodiments of the present invention.

FIG. 8 shows a set of sensors that may be used in implementing certain embodiments of the present invention.

FIG. 9 shows a user device showing the status of a temperature sensor according to one embodiment of the present invention.

An artisan of ordinary skill in the art need not view, within isolated figure(s), the near infinite number of distinct permutations of features described in the following detailed description to facilitate an understanding of the present invention.

### DETAILED DESCRIPTION OF THE INVENTION

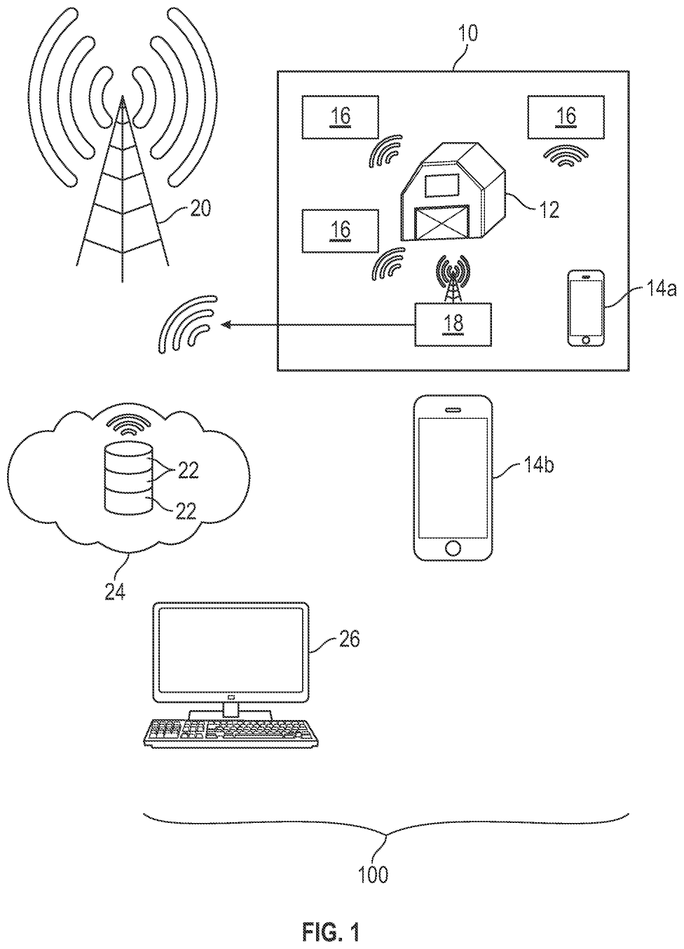

FIG. 1 shows an agricultural alarm system 100 that includes a geofence 10 outlining the boundary of an agricultural production facility 12 according to one embodiment of the present invention. The geofence 10 may be created by any known technology for creating a geofence. The geofence 10 is suitable to detect and record when a user's device 14a,b crosses into or out of the area defined by the geofence 10. It is contemplated that rather than geofence technology other similar technology may be used for sensing the presence of a device 14a,b within a defined area, such as wi-fi or Bluetooth beacons or other low energy network protocols. The agricultural production facility 12 may be any facility used for the production of agricultural products, such as such as pig barns, chicken houses, green houses, and the grounds immediately surrounding such structures. The users' devices 14a,b may be a portable programmable device capable of running software apps and including hardware to permit sensing its geographic location, such as GPS, for example the users' devices may be smart phones. The users' devices 14a,b will each be associated with a corresponding particular user, such that sensing the of the presence or absence of the device 14a,b from within the geofence area can be considered a good proxy for the presence or absence of the user.

A plurality of sensors 16, such as sensors to detect temperature, humidity, carbon dioxide levels, water levels, water meter readings, lack of electrical power or tripped breakers, open or closed doors, and the like are provided at the agricultural facility 12. The sensors 16 are connected, preferably by Wi-Fi or similar technology to a gateway 18 that in turn has a direct or indirect connection preferably via cellular data with a remote communication station 20, such as a cellular tower 20. The communication station 20 in turn communicates with at least one computer 22, and likely several computers 22 provided in a computing cloud 24. Additionally, a remote user interface 26 such as a computer and monitor with Internet access may be used to provide input and observe status.

According to one embodiment, the users' devices 14a,b are programmed with an app for use in conjunction with the alarm system 100. The app may include a screen with tiles that represent each of the sensors 16. The tiles may be color coded to indicate the status of the corresponding sensor. For example, when the sensor is sensing a condition within a desired or acceptable range, the tile may be colored or outlined in green. When the sensor initially senses that the parameter is outside the desired range the tile may be changed to yellow to indicate a warning condition. When the parameter is sensed to be too far outside the desired range, or without correction for too long, the tile may be changed to red to indicate an emergency situation. By selecting a tile representing a sensor on a user's phone, for example by touching the tile on a touchscreen, the app may cause a display to appear that displays the recent readings of the sensor, for example in a graphical form. Additionally, a color-coded tile may appear that displays how long the sensor has been at the current threat level (acceptable, warning, emergency).

The range of the desired sensor readings may be adjusted by users depending upon the permissions assigned to the users. The adjustment of the ranges may be done through the app on a mobile user device 14a, b or via a computer 26. Additionally, a user may have the ability to invite other users to join the alarm system 100.

The app may cause different notifications to be provided to users depending upon the location of the user and the level of the threat. For example, the user device 14a, which is located inside the geofence region 10 might provide a push notification or other alert (e.g., SMS message) upon the occurrence of a warning condition so that that a user on site can personally review the situation and resolve any causes of that resulted in the condition reaching the warning stage. Whereas the user device 14b located outside the geofence area 10 away from the agricultural production facility 12 might not provide any special notification to the user, other than the update of the tiles associated with the sensor 16. Alternatively, in an emergency situation, each of the users 14a and 14b might receive a push notification or other alert (e.g., short message service (SMS) message).

When a user responds to the condition, the user can acknowledge that they have responded, and the other users can be informed that the first user has responded to the condition. Again, this notification of the other users can be passive, by providing an indication on a tile or screen corresponding to the sensor 16, or can be more active via a push notification or SMS message.

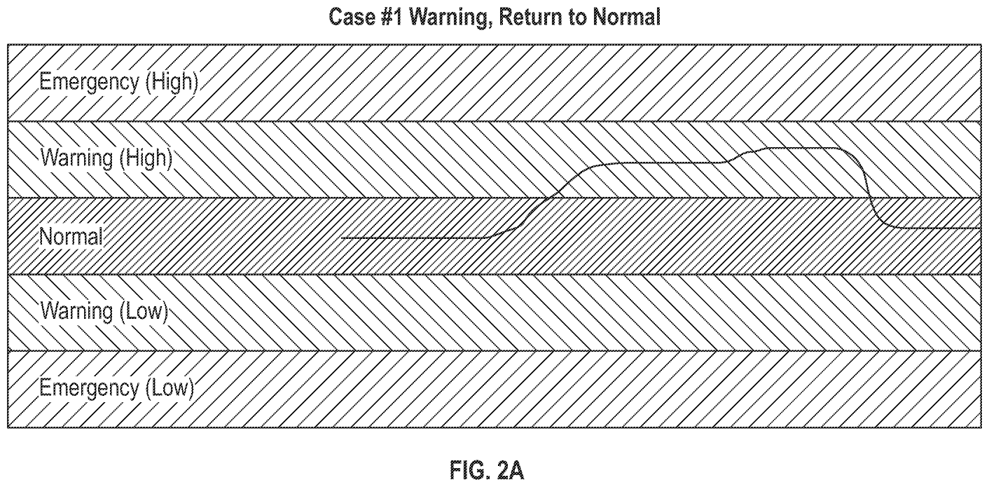

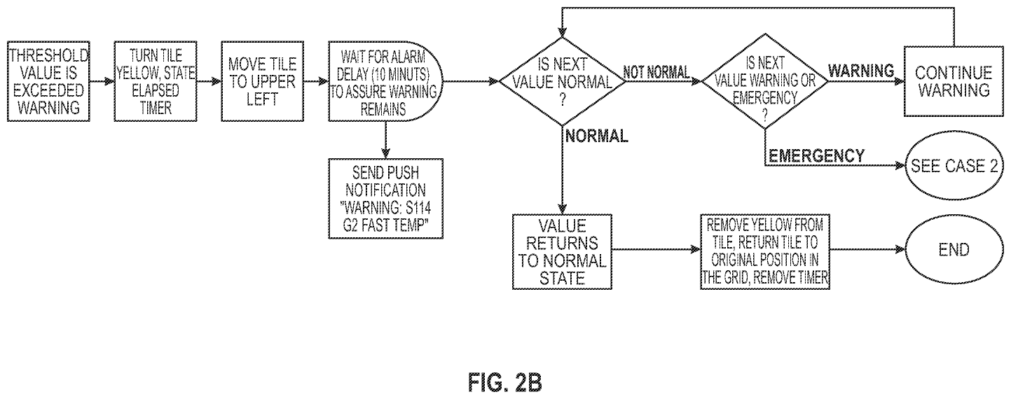

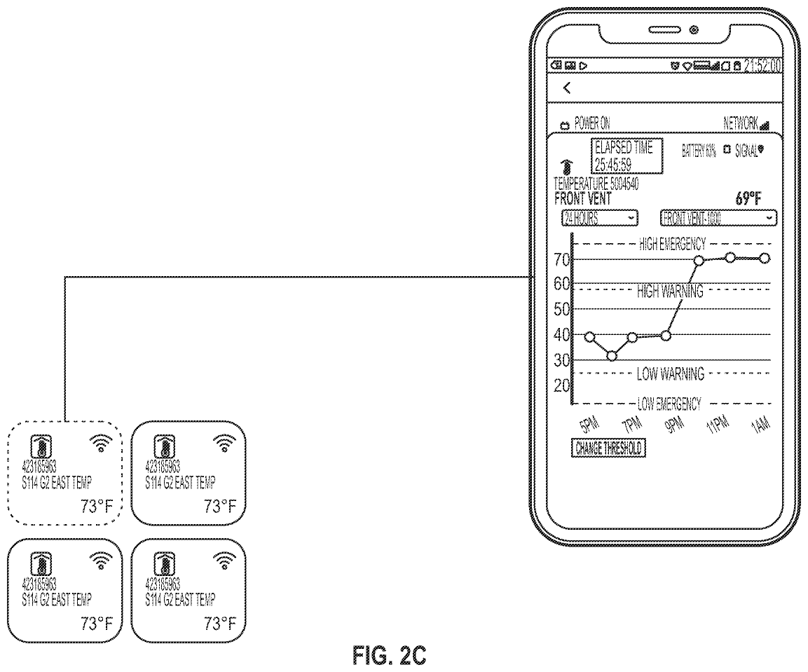

The operation of the alarm system 100 can be better understood with reference to the attached Figures relating to several example Cases. For example, FIGS. 2A-C illustrate a first case, referred to as Case 1 (warning, return to normal), a sensor 16 senses a value that is outside a desired range. In Case 1, an air temperature associated with a vent is sensed to be too high by a small amount. This is considered a warning condition. That is, the temperature is a concern, but because of either the amount the temperature is outside the desired range, or the time it is outside the desired range is not sufficient to be considered an emergency. The sensor 16 sends a signal that indicates the sensed temperature to the at least one computer 22 (i.e., cloud 24) via the gateway 18 and the cellular tower 20. The at least one computer 22 determines whether the temperature is outside the desired range. The at least one computer 22 then sends a signal to the user's devices 14a and 14b indicating that the warning condition exists. The app turns the tile corresponding to the tile yellow, starts an elapsed timer that shows how long the warning condition has existed, and moves the tile to the upper portion of the user's screen. The app then waits an alarm delay time (which is a parameter than can be set by users with appropriate permission), for example 10 minutes, and checks to see if the parameter is back in the normal range. If the parameter is back within the normal range, the tile is again turned green and the tile is removed from the upper part of the screen and returned to its regular position in the grid of tiles. The timer indicating time out of the normal range is stopped. If the parameter is still in the warning condition (i.e., outside normal, but not severely enough to be considered an emergency), the tile remains yellow and at the top of the screen with a warning timer still running. After another alarm delay time the process is repeated. On the other hand, if upon one of the rechecks the condition has progressed into the emergency range, then the alarm system 100 reacts according to the flow chart related to Case 2 below.

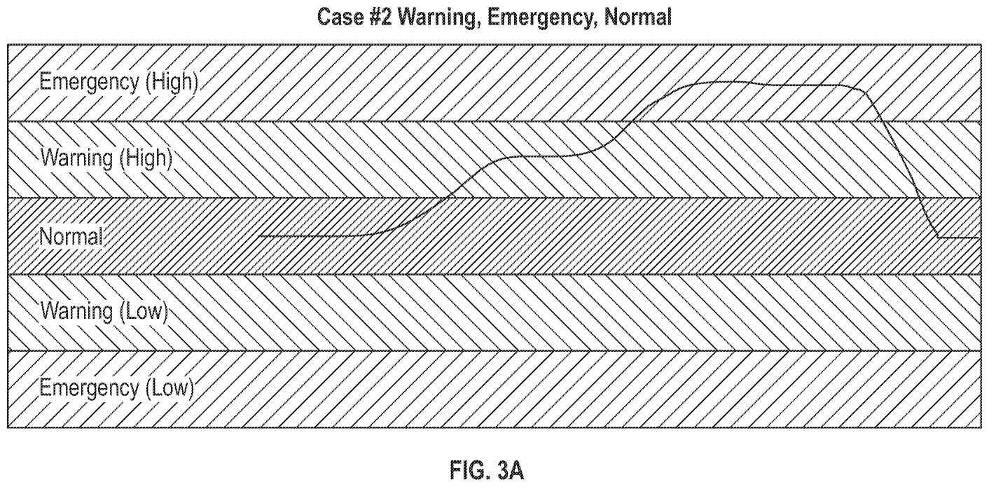

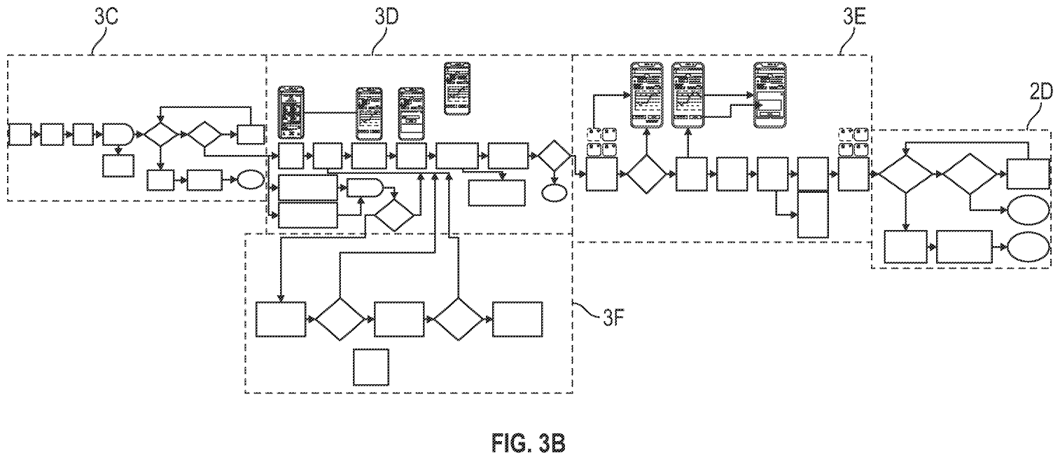

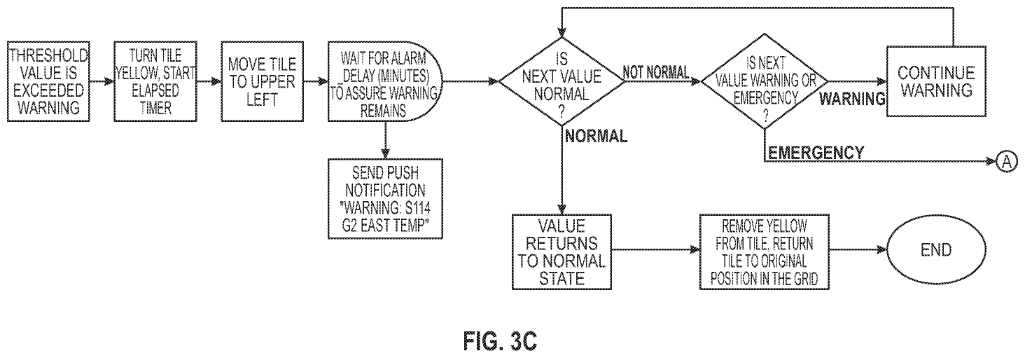

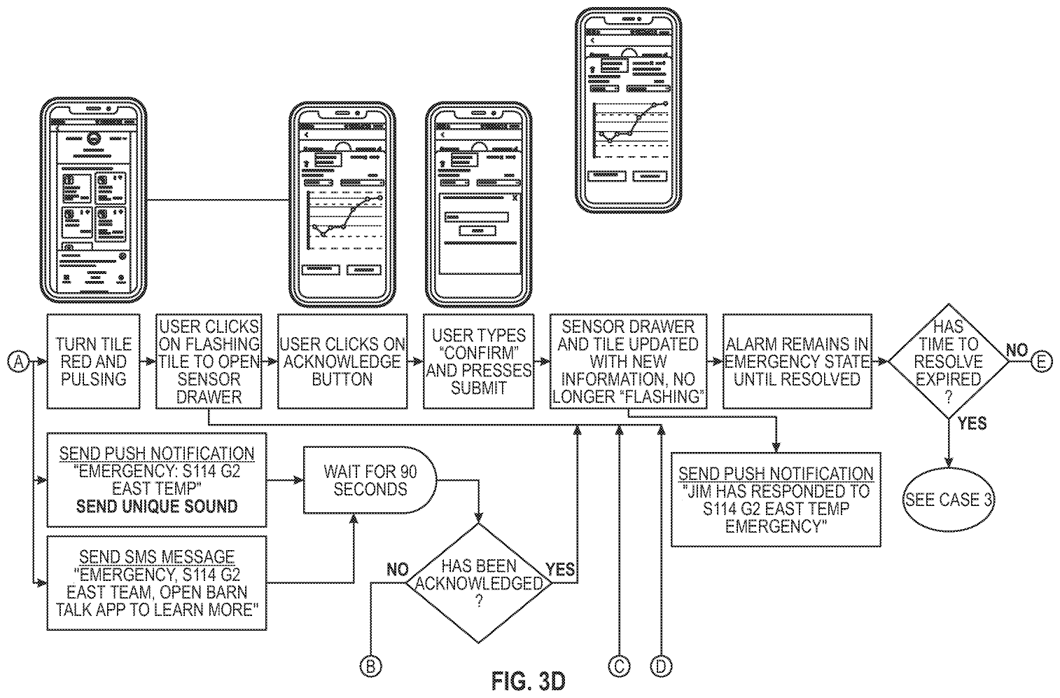

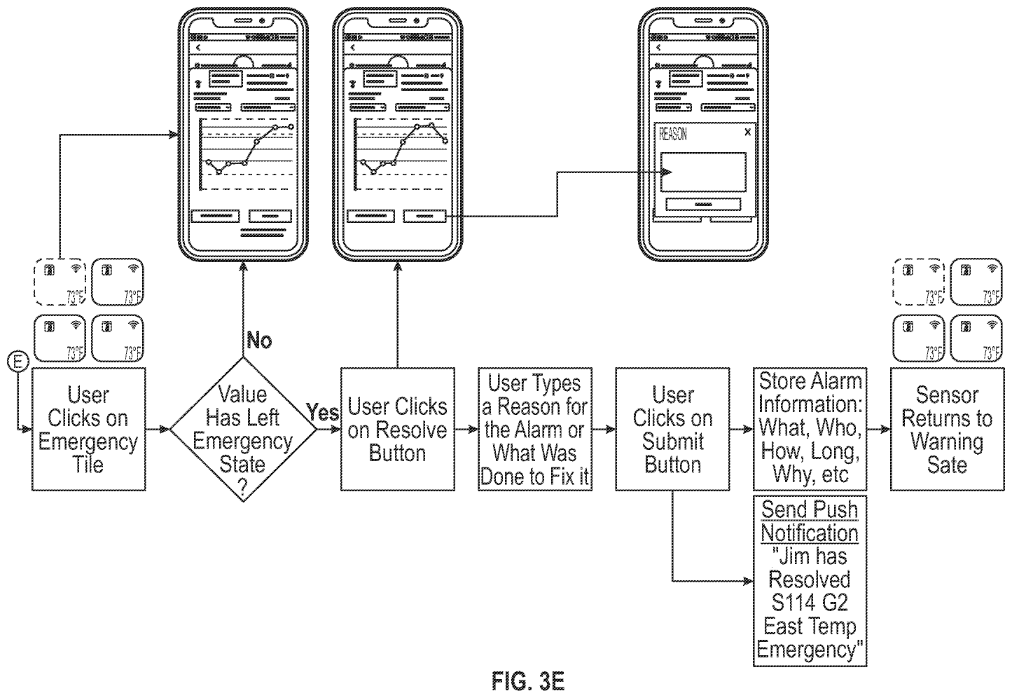

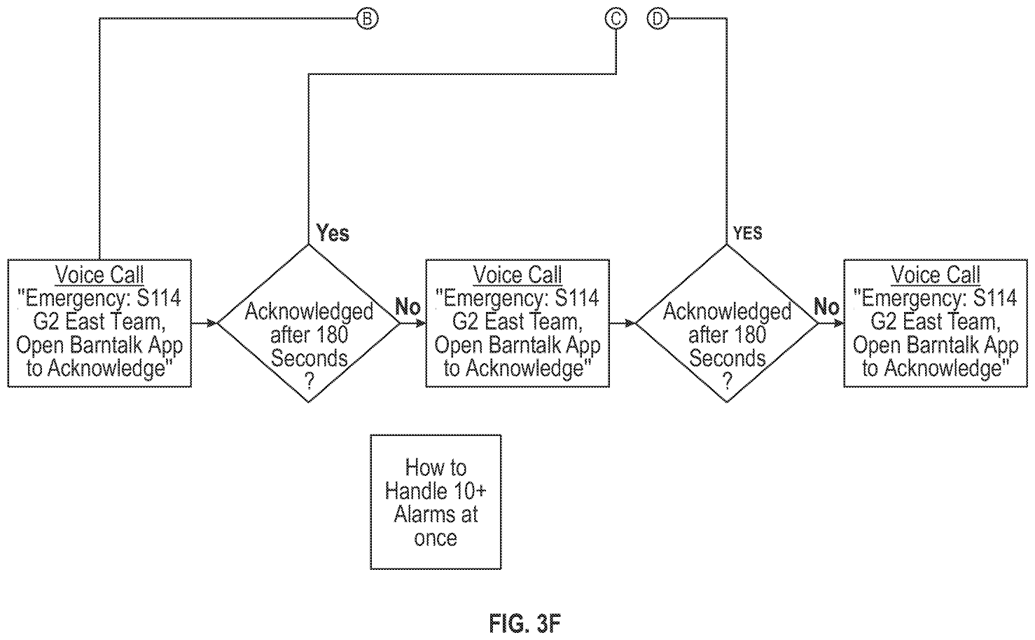

In Case 2 (warning, emergency, normal), as seen in FIGS. 3A-F the sensor 16 senses that the parameter (e.g., vent temperature) is outside the desired range and within the warning range (i.e., not so far outside range as to be considered an emergency situation). The sensor 16 sends a signal that indicates the sensed temperature to the at least one computer 22 (i.e., cloud 24) via the gateway 18 and the cellular tower 20. The at least one computer 22 determines whether the temperature is outside the desired range. The at least one computer 22 then sends a signal to the user's devices 14a and 14b indicating that the warning condition exists. The process initially proceeds as outlined above in Case 1. However, eventually on one of the re-checks the parameter is found to be outside the warning range and into the emergency range. At that point a push notification and/or SMS message is generated by the one or more computers 22 and is sent to the users 14a, 14b. Alternatively, the message may be sent initially only to users located within the geofence area 10. Within the app, the tile corresponding to the sensor in the emergency condition is turned red and flashing. A unique alarm sound may also be played to make sure the user gets notice of the emergency. The user can then click on the flashing tile to open more detailed information about the sensor 16, including preferably a graphical presentation showing the recent history of the sensor's readings. Within the detailed sensor page displayed on the screen of the user's device 14a by the app there is a virtual button for the user to touch and acknowledge the emergency. If the user selects the acknowledge button, the user will then be asked to confirm that the user is acknowledging the alarm. The other users will be sent a push notification (and/or SMS message) stating that the user has acknowledged the emergency. The screen corresponding to the sensor is updated to include a notice that the emergency has been acknowledged and identifying which user has acknowledged the emergency. The notice may also note the amount of time until another alarm will be sent (e.g., countdown time) if the condition has not been resolved. The tile with the elapsed time since the alarm condition was sensed remains red but is changed so that it is no longer flashing.

Still with reference to Case 2, when the acknowledging party has taken action to resolve the emergency, that user can touch a resolve button on the sensor screen, which causes the app to call up prompt and text box for the user to enter a reason or cause for the alarm and what was done to fix it. A push notification and or SMS message can then be sent to the users 14a and 14b informing them that the user has resolved the emergency. The sensor status on the sensor tile is returned to a warning (e.g., yellow) indication until an elapsed time for a recheck of the sensor 16 value. At that point, the process continues as outlined related to Case 1 after a warning condition exists. If the next value is normal the sensor tile is returned to the normal state color (e.g., green) and the tile is moved from the top of the screen back to its normal position in the grid of tiles. If the next value is in the warning range, the tile remains yellow, the tile remains at the top of the screen, and the warning timer continues to run until the next check of the sensor 16 value.

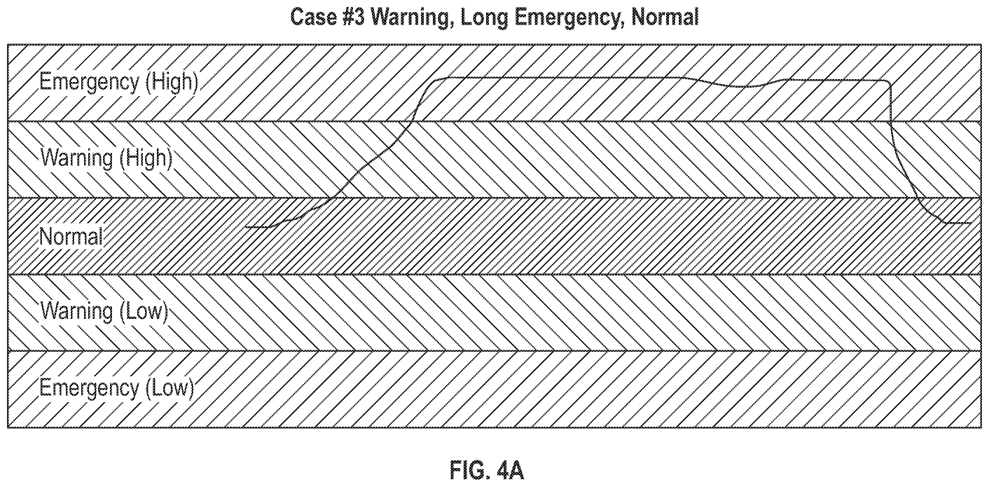

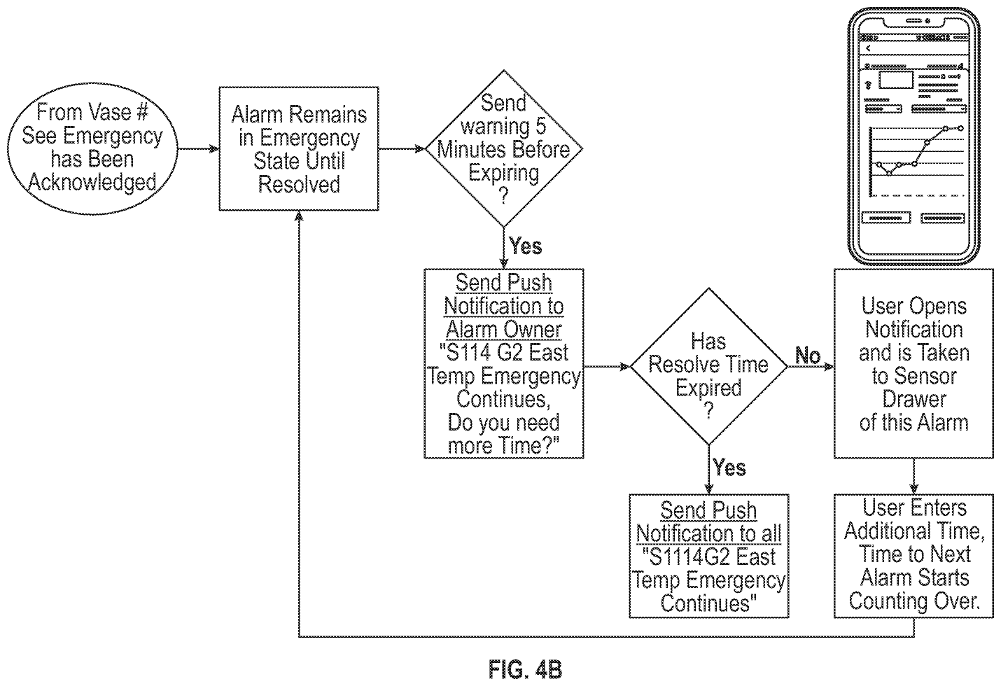

Finally, Case 3 illustrated in FIGS. 4A-B (emergency, acknowledgment, time expires without resolution, second acknowledgment, resolution) is similar to Case 2, except after the first user has acknowledged the emergency, the sensor remains in the emergency condition after an elapsed time upon recheck of the sensor 16 reading. The responding user (e.g. “alarm owner”) is sent a notification (e.g., push notification or SMS message) asking if the user needs additional time to resolve the emergency. Opening the notification causes the sensor screen to appear on the responding user's device 14a screen and the user is given the option to enter additional time needed to resolve the emergency. If the user enters additional time, the countdown time is reset to the additional time and continues to countdown as before until a set time period (e.g., five minutes) before the time expires where upon the same notification is sent asking if additional time is needed. If the countdown clock ever times out (reaches zero) a new notification (push notification or SMS message) is sent to all users that the emergency condition persists, the sensor tile is turned red and pulsing, and the requirement for an acknowledgment is repeated as in Case 2 above.

Additionally, the alarm system 100 may be adapted to permit users to receive notifications during warning and especially during emergency conditions of whether another user is inside the geofence area 10 and when another user either arrives or leaves the geofence area. This is useful for responding efficiently to alarm conditions, especially outside normal business hours when many or all of the users may be absent from the agricultural production facility 12. The system 100 may be adapted to send initial notifications to users that are within the geofence area 10 without the need to alert remote users until time has elapsed to permit the local user(s) to acknowledge and resolve the condition. The app may also provide that users can tell which other users are present within the geofence area 10 so that that the users can coordinate with each other to make sure the conditions are being efficiently resolved. For example, a user or users that are registered as being within the geofence area 10 could be notified of warning and emergency conditions before other users. Other users might be notified of the existence and identity of users that are already within the geofence area 10.

According to another feature the alarm system can be used to provide several geofence areas 10 related to a single agricultural production facility 12. These smaller areas 10 within the entire facility 12 may be used similarly as described with respect the larger geofence area 10 in that alarm conditions within the smaller area might be first directed for handling by users within the smaller area 10. If no one is within the smaller subarea 10 or no one within that small area 10 acknowledges the alarm condition, then the notification can be sent to all users within the larger geofence area 10, before ultimately being sent to all users if the alarm condition is not acknowledged by local user.

According to another feature additional users such as vendors might be added to the user group. Such users would have different and more limited permissions than users that have permission to respond to and resolve alarms. When a vendor crosses the geofence 10 border, certain users (stakeholders) might receive a notification that the vendor is present at the facility 12. Additionally, the app may permit a stakeholder to open doors or otherwise provide access to a vendor when the stakeholder receives notice that the vendor has crossed into the geofence area 10 without the stakeholder needing to be present at the facility. The stakeholder could then lock the door when the stakeholder receives notice that the vendor has crossed back out of the geofence area 10. Alternatively, the system 100 might permit a stakeholder to automatically unlock certain areas when the vendor is within the geofence area. For example, the system 100 may unlock certain doors while the vendor is present and then relock them when the vendor crosses outside the geofence area 10. A vendor user might be allowed to see whether the stakeholders are within in the geofence area 10.

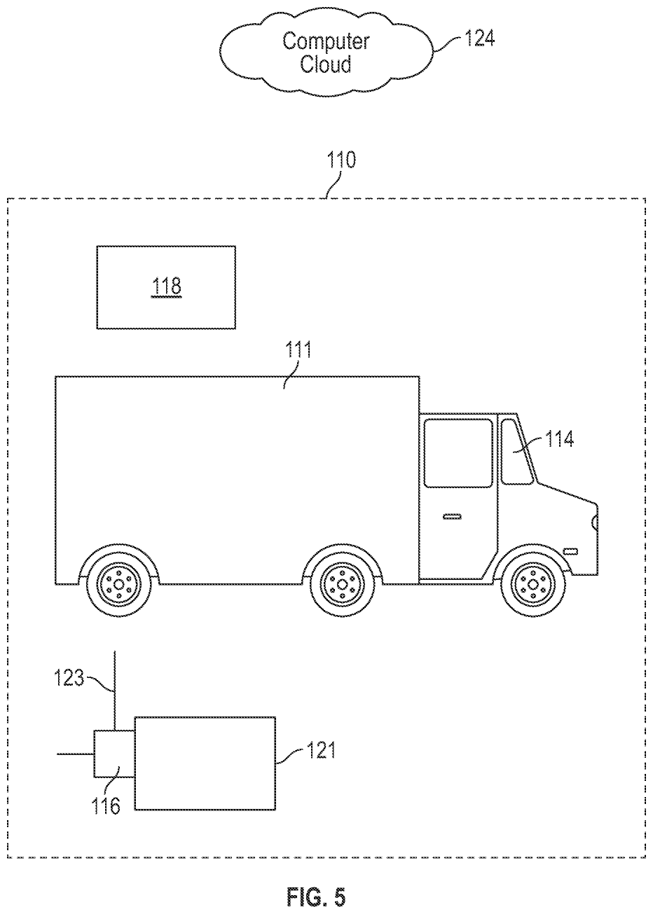

For example, as shown in FIG. 5, the system 100 might be set automatically open a lid 123 on a feed bin 121 when a specified vendor device 114 is within the geofence area 110 such that the vendor can unload feed into the bin 121 without ever exiting the vendor's truck 111. The feed bin 121 is equipped with structure that permits the lid 123 to be selectively opened and closed by a controller 116. The controller 116 is in communication with a gateway 118 (e.g., wifi router) that is in direct or indirect communication with a control computer, such as computer cloud 124. This feature has the benefit of being more convenient as well as limiting potential contamination by the vendor exiting and entering the truck 111.

It is contemplated that numerous variations, changes, and otherwise, which are obvious to those skilled in the art are to be considered part of the present invention.

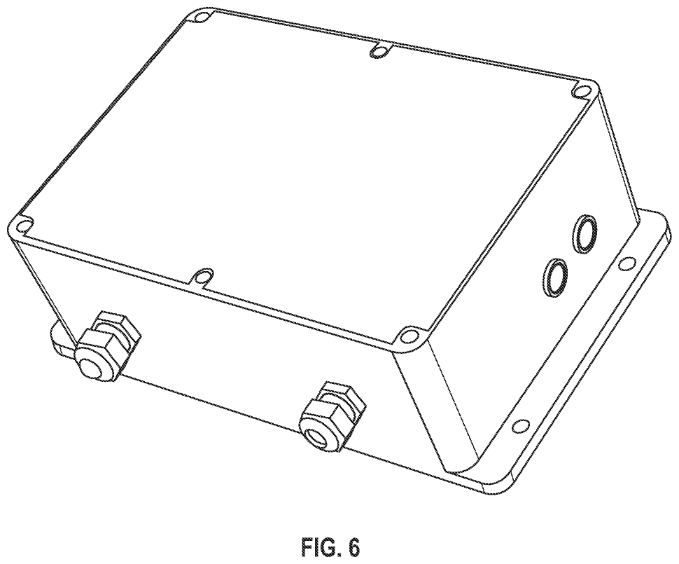

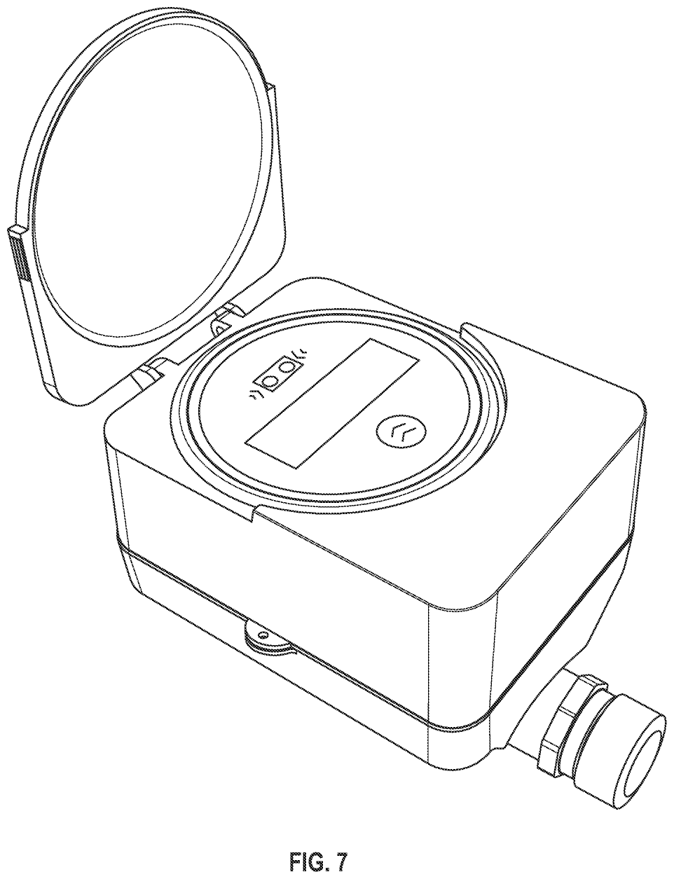

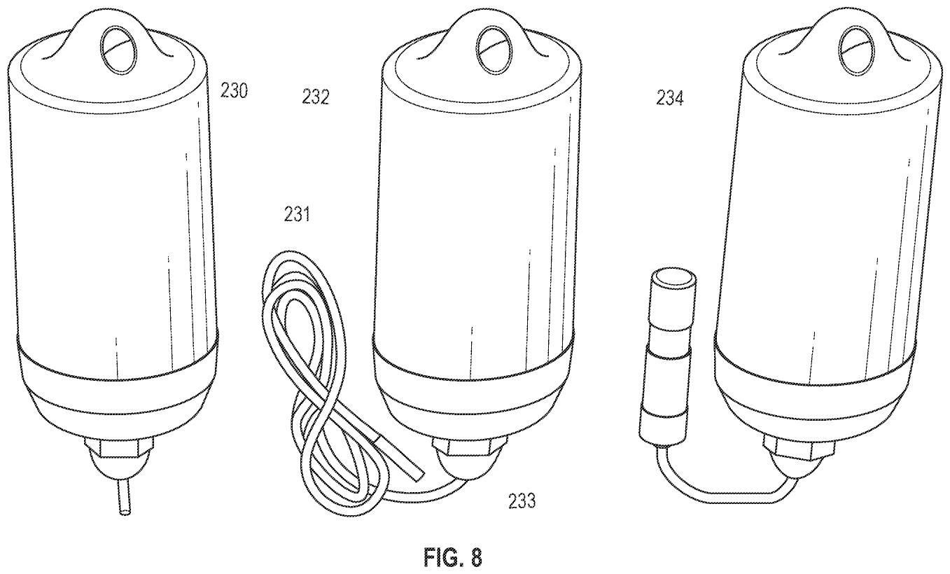

FIGS. 6-8 show components that may be used in implementing certain embodiments of the present invention. FIG. 6 shows a gateway 218. The gateway 218 may include inlets (not shown) for a LoRa (long range) antenna, such as a Low Power Wide Area Network (LPWAN) antenna to communicate with wireless sensors, and for a 2G/4G antenna to connect to the Internet. The gateway 218 may also include a power inlet 219 for connection to a power source, such as AC electricity. Preferably the gateway 218 will also be provided with a battery backup in case there is a loss of power. The gateway 218 may also include indicators lights 220 and 221 to indicate whether the gateway 218 is connected to the Internet and whether the gateway 218 is receiving power. FIG. 7 shows a water meter 220 that senses water flow. The water meter 220 may be an ultrasonic meter. The water meter 220 is adapted to communicate with the gateway 218 to provide a signal to indicate sensed water flow amounts to the gateway 218. The water meter 220 preferably includes a battery to provide power to the meter. The water meter 220 may periodically, for example every 8 hours, report the amount of water that flowed past the meter 220. A user with the app downloaded on their device can see when there is excess flow that may indicate a leak or other problem. FIG. 8 shows a set of sensors that may be used in certain embodiments of the present invention. The sensors include an indoor temperature sensor 230, an outdoor, or remote, temperature sensor 232, and a humidity sensor 234. The outdoor temperature sensor 232 includes an elongated cord 231 with a sensor element 233 at the end. The temperature sensor 232 can be mounted indoors and the sensor element 235 can located outside or at some other remote location.

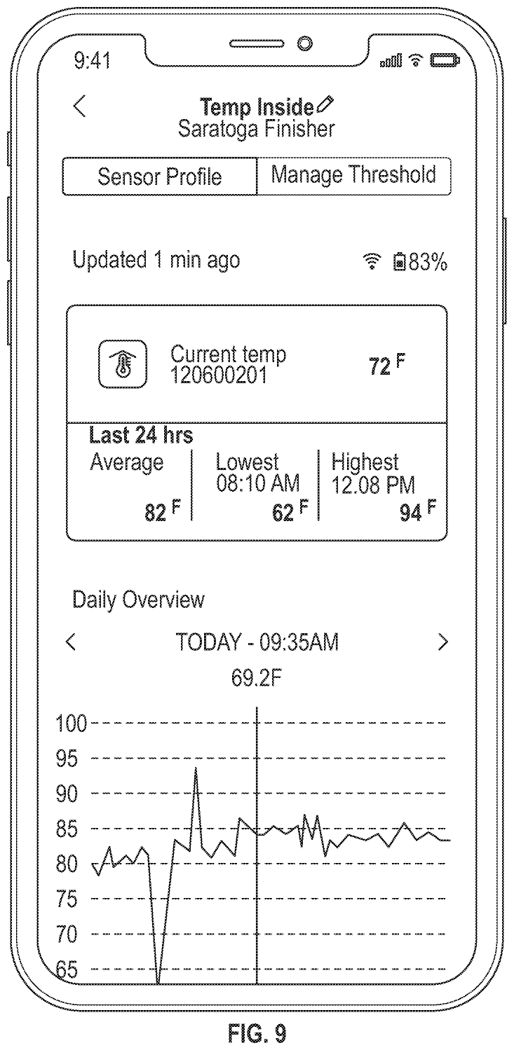

FIG. 9 shows a user device 300 that can be used in association with certain embodiments of the present invention. The device can be a mobile phone or other programmable device, for example a computer. In the device 300 shown in FIG. 9, the device 300 is showing information related to a temperature sensor. The display on the device 300 includes a graphic display of the sensor readings for period of time, for example the temperature readings for a 24-hour period. The display also includes a display portion showing information about the readings of the sensor, for example the average temperature, the lowest temperature and the highest temperature. The display also includes tools that permit a user to manage the threshold values—for example the normal range, warning ranges and emergency thresholds. It should be understood that the display could show information related to a different type of sensor, for example a humidity sensor, water flow sensor, electric current sensor, or it could be information about the status of alarm conditions for various sub areas of the geofence area 10. The display could show the status of the feed bin 121—e.g., whether the lid 123 is open or closed or whether the bin is full, empty, or close to empty. The control features on the display be used to permit access to various areas within the geofence or control which vendors can have access to various areas. The display may also show whether and which vendors or other users are present within a sub area within the geofence.

What is claimed is:

1. An agricultural alarm system for use in association with an agricultural production facility, the agricultural alarm system comprising:
a geofence outlining a boundary of an agricultural production facility;
at least one sensor located within the geofence boundary for sensing whether a physical property is within a desired range, is outside the desired in a warning range, or is outside the desired range and outside the warning range in an emergency range;
a plurality of user devices, each user device being associated with a corresponding user;
the geofence being adapted to sense whether a user device is located inside the geofence boundary;
at least one computing device including a nontransitory computer readable media adapted to receive signals from the at least one sensor indicating an alarm condition when the physical property is outside the desired range; and
the computer readable media being adapted to cause alarm notifications to be sent to a first group of user devices when the alarm condition exists, wherein members of the first group are determined based on their presence within the geofence boundary.

2. The agricultural alarm system of claim 1, wherein each user device is programmed with an app that causes a screen to display a tile that represents a status of the at least one sensor.

3. The agricultural alarm system of claim 2, wherein the tile is color coded to indicate the status of the at least one sensor.

4. The agricultural alarm system of claim 3, wherein the tile is a first color if the physical property is within the desired range, wherein the tile is a second color if the physical property is in the warning range; wherein the tile is a third color if the physical property is in the emergency range.

5. The agricultural alarm system of claim 1, wherein the at least one sensor is selected from the group consisting of: temperature sensor, humidity sensor, carbon dioxide level sensor, water level sensor, water flow meter, electrical meter, and open-door sensor.

6. The agricultural alarm system of claim 1, wherein the agricultural production facility includes a proximity sensor and wherein the computer readable media is adapted to provide access to an access area when the proximity sensor senses that a permitted user is near the proximity sensor.

7. The agricultural alarm system of claim 6, wherein the access area is a feed bin, wherein the permitted user is a vendor, and wherein access is provided by opening a feed bin lid.

8. The agricultural alarm system of claim 1, wherein the alarm notifications are sent through a short message system (SMS) message.

9. The agricultural alarm system of claim 1, wherein the alarm system notifications are sent by a voice call to the first group of user devices.

10. The agricultural alarm system of claim 1, wherein the computer readable media is adapted to send a notification to user devices of the first group indicating that a member of the first group has responded to the alarm condition if a member of the first group selects an acknowledgment button displayed by the app.

11. The agricultural alarm system of claim 10, wherein the computer readable media is adapted to cause second alarm notifications to be sent to the first group of users if an alarm condition persists beyond a first time limit without any member of the first group selecting the acknowledgment button displayed by the app.

12. The agricultural alarm system of claim 10, wherein the computer readable media is adapted to cause additional alarm notifications to be sent to a second group of users if an alarm condition persists beyond a first time limit without any member of the first group selecting the acknowledgment button displayed by the app.

13. The agricultural alarm system of claim 11, wherein the second group of users is determined independently of whether the users are within the geofence boundary.

14. The agricultural alarm system of claim 1, wherein the computer readable media is adapted to cause additional alarm notifications to be sent to a second group of users if the physical property is in the emergency range.
